(19) United States
(12) Patent Application Publication
(10) Pub. No.: US 2022/0149629 A1
(43) Pub. Date: May 12, 2022

(54) System for Power Conversion and Energy Storage

(71) Applicant: Cheesecake Energy LTD, Nottingham (GB)

(72) Inventor: Michael Simpson, London (GB)

(21) Appl. No.: 17/602,849

(22) PCT Filed: Apr. 14, 2020
(86) PCT No.: PCT/IB2020/053522

§ 371 Date: Oct. 11, 2021

(30) Foreign Application Priority Data
Apr. 11, 2019 (GB) 1905134.1

(51) Int. Cl. H02J 3/28; H02J 15/00; H02P 5/60

(52) U.S. Cl. CPC H02J 3/28; H02P 5/60; H02J 15/006

(57) ABSTRACT

A system for power conversion and energy storage is described. In an embodiment the system comprise a DC rotating electrical machine (1) comprising a DC rotor; an AC rotating electrical machine (2) comprising an AC rotor; and a (thermo-) mechanical energy storage system (known as a TMESS) (3). The TMESS comprises a central shaft, said central shaft charged and discharged with shaft power and selectively mechanically coupled to the DC rotor and to the AC rotor via clutch (4) to form a shaft train. Some source of DC generation such as photovoltaic cells (5) feeds electrical power into the DC electrical machine (1). There may also be local DC loads (8) supported by the system. The AC electrical machine (2) may deliver power to local AC loads (6), or draw power from the AC electrical grid (7).

### FIELD OF INVENTION

The current invention relates to a system for power conversion and energy storage, in particular to a system comprising a DC rotating machine, an AC rotating machine and an energy storage device.

### BACKGROUND OF THE INVENTION

Power generation from renewable energy sources (especially the sun and wind) is already (in 2019) less expensive than other generation forms based on so-called Levelised Cost of Electricity (LCoE), which simply divides the total electrical energy output by the corresponding marginal cost. As the penetration of renewable energy increases, it becomes important to consider how to reconcile the supply of electricity with the demand for it. Energy storage is one of the primary options for this balancing—and it can be a complete solution.

Some renewable energy generation naturally generates DC (direct-current) electricity. Photovoltaic (PV) panels are the most common instance of renewable energy generators that produce DC and because of the remarkable reductions in costs per kW of rated power that have been achieved, PV panels are becoming extremely widespread. Although most wind turbines are presently built to generate AC directly, there are strong arguments for using DC generators in some wind turbines—particularly where energy storage is envisioned. This point is developed further in a separate section below.

The present invention is motivated especially strongly by applications where DC electricity is generated (normally from renewable energy sources) and where there is a requirement ultimately to exchange some power (possibly both exporting and importing) with an AC (alternating-current) grid/bus. A specific and very common motivating application for this invention is the case of solar-plus-storage where a PV installation is coupled to an AC grid.

The present invention aims to at least ameliorate the aforementioned disadvantages.

### SUMMARY

According to a first aspect of the present invention, there is provided a system for power conversion and energy storage comprising: a DC rotating electrical machine comprising a DC rotor; an AC rotating electrical machine comprising an AC rotor; and a (thermo-)mechanical energy storage system (known as a TMESS) comprising a central shaft, said central shaft operable to charge and discharge the TMESS with shaft power and selectively mechanically coupled to the DC rotor and to the AC rotor to form a shaft train.

This invention comprises a system for power conversion and energy storage intended for use in contexts where some local DC generation provides some or all of the energy required for local electrical loads which may comprise some combination of DC and AC power draws. An energy storage device, such as a (thermo-)mechanical energy storage system (TMESS), enables some of the DC power to be put into storage whilst some is transformed into AC power.

As noted further below, a TMESS is broadly defined as a system that can be charged (at least partly) and discharged (at least partly) by the transmission of mechanical power into or out of the TMESS respectively by the central shaft.

A shaft train is broadly defined as a drive shaft that connects rotating shafts of the electrical machines. In this instance the shaft train means that the DC rotor of the DC rotating electrical machine, the AC rotor of the AC rotating machine and the central shaft of the TMESS are mechanically coupled. In embodiments it can be considered that gearbox elements may be used between one or more of the shaft train elements.

Typically the DC rotor of the rotating machine and the AC rotor of the AC rotating machine are mechanically coupled. The DC rotor (although it could be the AC rotor) is then mechanically coupled to the central shaft of the TMESS.

In some embodiments the rotor speed ratios between the DC rotor and the AC rotor are unity.

In embodiments, the power conversion and energy storage system may comprise the DC rotating electrical machine mechanically hard-coupled to the AC rotating electrical machine such that the rotors of both machines always turn together at all times. Similarly, in embodiments the thermo-mechanical (or purely mechanical) energy storage system has a single central shaft for mechanical power input/output that is mechanically coupled to the combined rotors of the DC and AC electrical machines. Accordingly the DC rotor and the AC rotor may be mechanically coupled to the central shaft by direct couplings.

In embodiments the system may comprise a clutch arrangement to mechanically decouple the DC rotor and the AC rotor from the central shaft so that the DC rotating machine and the AC rotating machine can convert power in one or both directions between AC and DC with no power being exchanged with the energy storage device. By placing a clutch in place between the energy storage device (such as a TMESS) and the coupled DC and AC machines the electrical machine rotors may continue to spin even when the TMESS system is stationary. Accordingly (apart from small power losses) the sum of electrical power entering the DC machine and the electrical power entering the AC machine is zero.

In some embodiments, the energy storage device, such as the TMESS may comprise a single set of mechanical power-conversion equipment connected to the central shaft which is reversible so that the same equipment can serve to charge and discharge the energy store.

In some other embodiments, the TMESS may comprise a two discrete sets of mechanical power-conversion equipment of which only one is mechanically connected to the central shaft at any one time and where one set of power-conversion equipment serves to charge energy store and the other set of power-conversion equipment serves to discharge that store.

In some embodiments the energy storage device may further comprise a mechanical power transmission, and wherein shaft power used for charging the energy storage device passes along one branch of the mechanical power transmission and shaft power emerging from discharging of the energy storage device is routed along a different branch of mechanical power transmission.

A system for power conversion and energy storage described herein is intended for use in contexts where some local DC generation provides some or all of the energy demanded by local electrical loads (possibly comprising both DC and AC loads) and where energy storage is provided by a (thermo-)mechanical energy storage system. The inclusion of both DC and AC rotating electrical machines, permanently mechanically coupled, within this system enables the efficient conversion between DC power (from the local generation) and AC power at a marginal cost lower than the marginal cost of a power-electronic converter. Moreover, the losses incurred in the AC-DC conversion for the new system are lower than those of the equivalent power-electronic converter. There are additional benefits to the electrical power-conversion using the pair of electrical machines and chief among these additional benefits is the natural provision of real inertia.

The present invention relates to applications where the energy storage device involves physical rotation of a shaft in both charge and discharge modes. We refer to such energy storage systems as “thermo-mechanical” or “mechanical” energy storage systems and for brevity we refer to these sets collectively as “(thermo-)mechanical” energy storage systems and further abbreviate this to “TMESS”. Such systems include pumped-hydro, pumped-thermal, compressed-air and flywheel energy systems. Because this shaft plays a central role in the description of the present invention but may not be the only shaft in the system, we will refer to this shaft as the “central shaft”.

In the case of a pumped-hydro energy storage system, the central shaft could be integral with the main rotor of a reversible pump/turbine. Alternatively, separate pump and turbine units might both be connected directly to the central shaft or they might each be connectable to that central shaft via a clutch of some description.

In the case of a compressed-air energy storage system, the central shaft could be integral with the main rotor of a reversible compressor/expander machine. Alternatively, discrete compressor and expander units might each be connected directly to that central shaft or they might each be connectable to that shaft via a clutch of some description.

In the case of pumped-thermal energy storage systems, the central shaft may be mechanically connected to one compressor and one expander at all times when the energy storage system is either charging or discharging. In some instances, the compressor and expander machines can switch roles and the same machines can be be connected at all times of system charging/discharging. In other instances of pumped thermal energy storage, the compressor and expander connected during charging can be different from the compressor and expander connected during discharging.

In all such cases, an AC electrical machine (normally a synchronous machine) may exchange mechanical shaft power at the central shaft with electrical power at the terminals of the electrical machine. By coupling a DC machine mechanically to the same central shaft, (either directly or indirectly through a gearbox/pulleys-plus-belt system/sprockets-plus-chain system), we achieve the ability to convert power between the AC and DC electrical terminals.

The use of mechanically-coupled AC and DC machines for the purposes of exchanging power between an AC grid/bus and a DC grid/bus is far from new. Indeed, long before power-electronic converters were prevalent, so-called “Ward-Leonard” sets were present as a means of converting power from AC electricity at one frequency into power at a different AC frequency. This aspect of the present invention is clearly not new. However, novelty arises because of the combination of a pair of electrical machines with the central shaft of an energy storage device, such as a TMESS. With this combination either the DC machine or AC machine can be used to charge the energy storage system by pushing mechanical power into the central shaft. Alternatively they may both be used simultaneously to inject shaft power into central rotor of the storage device for storage within an energy store. Similarly, when the energy storage is being discharged, mechanical power emerges from the energy store and is provided as shaft power to the central shaft, and this mechanical shaft power may be used to drive the AC machine to generate AC electrical power or (rarely) it may be used to drive the DC machine to generate DC electrical power. Additionally, there is a mode of operation in which some positive or zero amount of DC power is entering the system from the DC bus, some positive or zero amount of AC electrical power is emerging from the system via the AC machine and where most of the difference between the power entering the system and the power leaving it is absorbed by these two power levels.

Energy storage can be done with electro-chemistry in batteries which may be flow batteries or fixed-charge devices (i.e. the non-flow-batteries). These electrochemical systems invariably work with DC (direct-current) electricity. The present invention does not relate to systems where the only energy storage present is electrochemical because these energy storage provisions do not involve a central shaft that must rotate when the energy storage system is either charging or discharging.

Similarly, this invention does not relate to systems where the primary local source of generation develops AC electrical power.

An advantage of this invention is that the capital cost of an inverter can largely be spared. Instead of paying for a (thermo-)mechanical energy storage system (TMESS) that takes in and exports AC electrical power as well as an inverter for converting power from the DC generation into AC using an inverter, the system developer can instead pay for the same TMESS plus an appropriate DC electrical machine. At sufficiently high power levels, the DC machine will generally be significantly less expensive than an inverter of the same power. As a result of the continued reduction in the cost of PV panels, it has recently (2019) started to become common for the rating of the inverter to be lower than the peak power rating of the PV panels. This approach improves the utilisation of the inverter but disimproves the utilisation of the panels themselves with the overall result that the system is more cost effective.

A further advantage of this invention arises whenever the AC machine is connected to the grid and spinning. Then, the AC machine delivers “real inertia”—which automatically helps to limit the rate of change of frequency. Inertia is a useful commodity to every AC electrical grid and one whose value is increasing rapidly as the penetration of renewable power increases.

Another advantage of this invention also arises whenever the AC machine is connected to the grid and spinning. The AC machine can deliver substantial “fault currents” when some undesirable occurrence in the nature of a short-circuit arises. Fault currents are essential to enable the isolation of the fault. In the simplest of all circuit protection strategies, fault currents simply burn a fuse and this breaks the circuit. Power electronic converters are not able to provide such fault currents easily because the power switches in these devices have extremely short time-constants.

In summary, this patent concerns systems which involve energy storage involving physical rotation of a machine shaft (the central shaft) in both the charge and discharge modes and which have electric power exchanges with both a DC side and an AC side and where there is sometimes a net through-flow of power (i.e. the DC side is outputting power whilst power is entering at the AC side or vice-versa).

As noted above, in embodiments the energy storage device comprises an energy store, said energy store storing and/or delivering shaft power to the central shaft in the form of pressurised air. Alternatively the energy storage device may store and/or deliver energy by pumping heat to, and recovers energy by drawing energy from, a heat engine. Alternatively the energy storage device comprises an energy store, said energy store storing energy obtained from the central shaft in the form of liquefied air. And further alternatively the energy storage device comprises an energy store, said energy store storing energy obtained from the central shaft in the form of one or more of pressurised air, pumped heat, liquefied air and pumped water.

In a broad example, there is described a system for power conversion and energy storage comprising a DC rotating electrical machine, an AC rotating electrical machine and an energy storage facility that may be charged and discharged with shaft power in which system the rotors of the three machines are mechanically coupled at least sometimes so that the rotor speed ratios are fixed at those times. The fixed speed ratios may be unity and the connections between the three rotors may be direct couplings. The mechanical coupling between rotors may be present at all times.

In embodiments, the DC electrical machine may be coupled to work in conjunction with a wind turbine that generates DC directly. For wind speeds below rated wind speed, the optimal rotational speed of a wind turbine rotor is proportional to the wind speed. Some wind turbines use a direct-drive generator where all of the power from this generator passes through a power-electronic converter to output fixed-frequency AC power. For machines of this nature, the present invention can reduce cost by replacing the power-electronic converter by a simple rectifier so that the electrical output will be DC power.

In some other embodiments the AC electrical machine may be coupled to work in conjunction with a wind turbine having a gearbox and an AC generator to generate AC directly. This AC generator may feed all of its power through a power-electronic converter. In that case, the present invention would also offer some cost advantage by replacing the power-electronic converter by a simple rectifier—just as is the case for a direct-drive AC generator.

In yet other designs, the wind turbine uses a gearbox and a so-called “DFIG” (doubly-fed induction generator). DFIGs enable the generator to produce AC power at the correct frequency even when the rotor speed is not identical to grid frequency or a fixed integer submultiple of that (a 4-pole synchronous generator produces 50 Hz output when the rotor is spinning at 25 cycles per second and a 6-pole pole synchronous generator produces 50 Hz output when the rotor is spinning at 16.666 cycles per second). DFIGs have slip-rings and brushes just as a DC machine has a commutator and brushes. The DC machine has similar cost to a DFIG machine but the DFIG requires a power-electronic converter whose cost is significant. Also, the DFIG may be able to offer only a limited range of “slip” (slip is the difference in speeds between synchronous speed and the actual running speed of the generator). A DC machine would naturally be able to cover the full speed range. A simple swap-out between DFIG and DC machine would be logical in all cases where it was possible to use DC power output at little or no marginal cost.

These and other aspects of the invention will be apparent from, and elucidated with reference to, the embodiments described hereinafter.

### BRIEF DESCRIPTION OF THE DRAWINGS

Embodiment of the invention shall now be described in detail by way of example and with reference to the accompanying drawings in which:

FIG. 1 shows a schematic representation of system for power conversion and energy storage comprising a DC rotating machine, an AC rotating machine and an energy storage device according to an embodiment of the present invention;

FIG. 2 shows a schematic representation of the energy storage device of FIG. 1.

It should be noted that the Figure is diagrammatic and not drawn to scale. Relative dimensions and proportions of parts of the Figure have been shown exaggerated or reduced in size, for the sake of clarity and convenience in the drawings. The same reference signs are generally used to refer to corresponding or similar feature in modified and different embodiments.

### DETAILED DESCRIPTION OF EMBODIMENTS

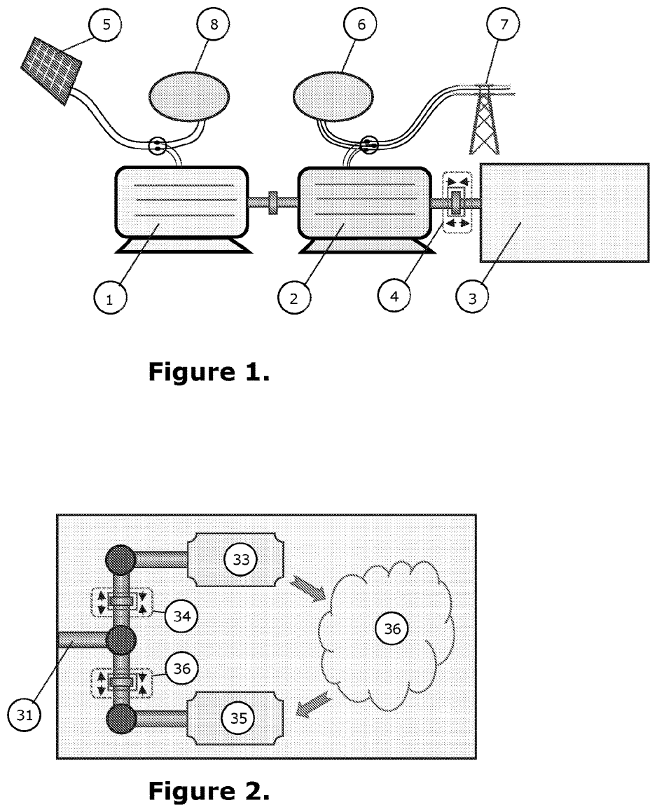

FIG. 1 shows a schematic diagram of the simplest representation of this system. This figure shows a DC electrical machine (1), such as a rotating DC motor/generator, comprising a DC rotor (along with other typical DC electrical machine components such as a stator and the like) directly-coupled to an AC electrical machine (2). The AC electrical machine 2 is also typically a rotating AC motor/generator and comprises an AC rotor (and other AC electrical machine components such as a stator and the like). The DC rotor and the AC rotor are mechanically coupled and form a composite electrical machine.

### COMPONENTS OF THIS INVENTION

The essential components of the system of this invention are:
(1) A DC electrical machine
(2) An AC electrical machine coupled directly to the above DC machine
(3) A (thermo-)mechanical energy storage system (TMESS)
(4) A clutch capable of coupling/de-coupling the pair of electrical machines from the central shaft of the (thermo-)mechanical energy storage system.

As shown in FIG. 1, the AC rotor is coupled to a central shaft 31 of a TMESS (3) via a clutch (4) mechanism. Some source of DC generation (5), such a PV cells or the like, feeds electrical power into the DC electrical machine (1), and the AC electrical machine (2) delivers power to local AC loads (6) or draws power from the AC electrical grid (7). In some implementations of the present invention, there could be local DC loads (8) also supported by the system.

The DC machine 1 is typically a wound-field DC machine 1 such that the (back-)EMF developed by the machine 1 can be controlled independently of the speed. In some embodiments a main magnetic field of the DC machine 1 can be supplied mainly by permanent magnets on a stator magnetic circuit, with relatively small field windings also provided so that the magnetic field of the stator magnetic circuit can be adjusted slightly.

Similarly, the AC machine 2 is typically a wound-field synchronous machine such that the (back-) EMF developed by the AC machine 1 can be controlled independently of the rotor speed. In some embodiments the main magnetic field of this AC machine 1 can be supplied mainly by permanent magnets on the AC rotor magnetic circuit with relatively small field windings also provided so that the AC rotor magnetic field can be adjusted slightly. The currents acting on the AC rotor to either provide or adjust the rotor magnetic field would typically be sourced from an exciter—following standard practice in synchronous generator design.

FIG. 2 shows a decomposition of the TMESS (3) into the central shaft (31) which may be linked to a charging machinery set (33) via a mechanical-transmission-for-charging (32) or to a discharging machinery set (35) via a mechanical-transmission-for-discharging (34). The charging action results in energy being placed into an energy store (36) (which may comprise two or more discrete energy stores of the same or different types). Similarly, the discharging action results in energy being drawn out of that energy store (36).

### Operating Modes of the System of this Invention

The system disclosed in this invention has four main operating modes:

(A) Quiescent

(B) Charging

(C) Discharging

(D) Free-Spinning

When the system is quiescent (mode A), neither the electrical machines nor the central shaft of the (thermo-)mechanical energy storage system (TMESS) are turning. Both electrical machines would normally be isolated from their respective buses in this state so as to prevent losses from occurring in the electrical machines and to prevent torques from arising in them.

When the system is charging (mode B), net electrical power is flowing into the two electrical machines. In this mode, it may often be that substantial power is flowing into the DC machine whilst at least some AC power is being withdrawn from the AC machine, and the remainder of the power (apart from losses) is flowing into the central shaft of the TMESS.

When the system is discharging (mode C), net electrical power flows out from the two electrical machines. In mode C, it would most often be the case that negligible power emerges from the DC machine and that the only significant power is AC power being drawn from the AC machine. The net output electrical power is all drawn from the TMESS via its central shaft. Some DC loads (such as computer power rails and power for LED lights) may be present “behind the meter” and these loads could be drawn from the DC machine.

In the free-spinning mode (mode D), the central shaft of the TMESS is declutched from the combined DC+AC electrical machine set. The DC+AC electrical machine set may be considered to be a composite electrical machine. Most commonly in this mode, significant electrical power flows into the DC electrical machine and most of this power is fed into the AC electrical machine through the mechanical connection of the two rotors. Then AC electrical power emerges from the AC electrical machine—either for direct use to drive some load or for injection into the AC electricity grid.

The (thermo-)mechanical energy storage system in this case is charged by injecting net electrical power into the pair of electrical machines such that mechanical power flows into the central shaft of the (thermo-)mechanical energy storage system. The mechanical energy is converted into a storable form and held. The (thermo-)mechanical energy storage system is charged by converting the stored energy back into the form of mechanical energy at the central shaft. The mechanical power flowing from the central shaft then turns the two electrical machines simultaneously and enables both to generate—though normally most output power would emerge from the AC machine.

From reading the present disclosure, other variations and modifications will be apparent to the skilled person. Such variations and modifications may involve equivalent and other features which are already known in the art of energy storage or conversion, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, and reference signs in the claims shall not be construed as limiting the scope of the claims.

1. A system for power conversion and energy storage comprising:
a DC rotating electrical machine comprising a DC rotor
an AC rotating electrical machine comprising an AC rotor; and
a (thermo-)mechanical energy storage system (TMESS) comprising a central shaft, said central shaft operable to charge and discharge the TMESS with shaft power and selectively mechanically coupled to the DC rotor and to the AC rotor to form a shaft train.

2. A system for power conversion and energy storage as described in claim 1 wherein the DC rotor and the AC rotor are selectively mechanically coupled to the central shaft by direct couplings such that rotor speed ratios between the DC rotor, AC rotor and the central shaft are unity.

3. A system for power conversion and energy storage as described in claim 1 wherein the DC rotor and the AC rotor are mechanical coupled to the central shaft at all times.

4. A system for power conversion and energy storage as described in claim 1 further comprising a clutch arrangement to mechanically decouple the DC rotor and the AC rotor from the central shaft so that the DC rotating machine and the AC rotating machine form a composite electrical machine, said composite electrical machine configured to convert power in one or both directions between AC and DC with no power being exchanged with the TMESS.

5. A system for power conversion and energy storage as described in claim 1 wherein the energy storage device further comprises a mechanical power transmission, and wherein shaft power used for charging the TMESS passes along one branch of the mechanical power transmission and shaft power emerging from discharging of the TMESS is routed along a different branch of mechanical power transmission.

6. A system for power conversion and energy storage as described in claim 1 wherein the TMESS comprises an energy store, said energy store storing and/or delivering shaft power to the central shaft in the form of pressurised air

7. A system for power conversion and energy storage as described in claim 1 where the TMESS stores energy by pumping heat from a cold store to a hot store, and wherein it releases energy by employing a heat engine to extract work from a reverse flow of heat.

8. A system for power conversion and energy storage as described in claim 1 where the TMESS stores its exergy in the form of liquefied air.

9. A system for power conversion and energy storage as described in of claim 1 where the TMESS comprises an energy store, said energy store storing energy obtained from the central shaft in the form of one or more of pressurised air, pumped heat, liquefied air and pumped water.

10. A system for conversion and energy storage as described in claim 1, wherein the central shaft is directly mechanically coupled to the AC rotor, and wherein the DC rotor is directly mechanically coupled to the AC rotor.
